(19) United States
(12) Patent Application Publication
(10) Pub. No.: US 2004/0189780 A1
(43) Pub. Date: Sep. 30, 2004

(54) Image forming apparatus and image scanning apparatus

(75) Inventor: Susumu Sato, Saitama-shi (JP)

Correspondence Address: YOUNG & THOMPSON, 745 SOUTH 23RD STREET 2ND FLOOR, ARLINGTON, VA, 22202

(73) Assignee: FUJI PHOTO OPTICAL CO., LTD., SAITAMA-SHI (JP)

(21) Appl. No.: 10/807,179

(22) Filed: Mar. 24, 2004

(30) Foreign Application Priority Data
Mar. 26, 2003 (JP) 2003-084868

(51) Int. Cl. B41J 2/385

(52) U.S. Cl. 347/118

(57) ABSTRACT

In an image forming apparatus, unnecessary light emitted from a light source is irradiated to a solar battery panel in printing or reading an image, and in a standby state. The solar battery panel is provided inside of a light-quality adjusting unit or a balance filter unit, and also provided in a surface to which the light from the light source is irradiated. The solar battery panels are arranged so as to cover gaps: the gap generated between the light-quality adjusting unit or the balance filter unit and the discussion box and the gap generated between the diffusion box and the film carrier. The solar battery panel converts the light from the light source to the electricity. The electricity is charged in a battery to drive a cooling fan.

### BACKGROUND OF THE INVENTION

1. Field of the Invention

The present invention relates to an image forming apparatus and an image scanning apparatus, and more particularly to an image forming apparatus and an image scanning apparatus in which light emitted from a light source toward an image carrying medium is utilized effectively.

2. Description of the Related Arts

Recently, in view of utilizing resources effectively and preventing global warming, the demand for energy saving is increasing. For example, in the projector disclosed in Japanese Patent Laid-Open Publications No. 6-175128, the infrared radiation emitted from a light source, which is not used for projecting an image, is guided to the outside of a photographic light path by using a device such as a mirror, and irradiated to a photoelectric converting device or a thermoelectric converting device to generate electricity. The electricity is used as part of the energy for driving the projector, so that the infrared radiation can be utilized effectively.

In addition to the abovementioned projector, with regard to a photographic printer for printing an image recorded in a photographic film in a photosensitive material, and a scanner for reading the image recorded in the photographic film by use of an imaging device such as a CCD, unnecessary light which is not illuminated to the photographic film is required to be utilized effectively.

In order to stabilize alight amount and a light quality, a halogen lamp used as the light source in various printers is turned on not only in printing the image but in a standby state. Therefore, a black shutter is provided between the light source and a photosensitive material, and open only when the image is exposed and printed; however, when the black shutter is closed, the light emitted from the light source is conventionally wasted. For example, in the photographic printer, the power is generally turned on about 10 hours per day. The operating time of the printer for exposing and printing is about 2 hours of the 10 hours. The power of the printer is reduced to about 60% for the remaining 8 hours in view of the life of the halogen lamp and the energy saving. When the light-utilization ratio in terms of time is calculated, the operating time is 2 hours, whereas an unoperated time is equivalent to 4.8 (8×0.6) hours, so that the light-utilization ratio in terms of time is 2/(2+4.8)×100=29.4%. Thus, 70.6% is not utilized even if the halogen lamp is turned on.

In addition, light emitted from the light source is not entirely illuminated to the photosensitive material even when printing is performed. In the light illuminating toward the photographic film, the light reflected on each part of the printer is diffused around as leak light. As a result, the leak light becomes the unnecessary light. If a halogen lamp light path is surrounded with a mirror tunnel in order to prevent the light from leakage, it is well-known that an emitted light amount is increased up to 30%. If the proportion of the unnecessary light is calculated back, supposing that the proportion of the unnecessary light is 30% of the light illuminated to the photosensitive material, the proportion of the light used effectively results in [1/(1.0+0.3)]×100=76.9%. Namely, the remaining light of 23.1% is the unnecessary light. Accordingly, in the light emitted from the light source at the time of activating the printer, the proportion of the light actually used for exposing and printing is much smaller.

### SUMMARY OF THE INVENTION

An object of the present invention is to provide an image forming apparatus and an image scanning apparatus in which light emitted from a light source can be used effectively in printing or reading an image and in a standby state.

In order to achieve the above object, an image forming apparatus and an image scanning apparatus of the present invention are provided with a photoelectric converting member for generating electricity by converting projection light which does not reach a photosensitive material.

In a preferable embodiment of the present invention, the photoelectric converting member is attached on a surface of the light source side of a shutter member and an inner surface of a housing for containing balance filters, and arranged in a position to cover gaps: a gap between a light-quality adjusting section or a light correcting section and a light diffusing section and a gap between the light diffusing section and a feeding device.

In another embodiment of the present invention, an image forming apparatus is provided with a reflection control member, which is a digital micro-mirror device (DMD) for reflecting the projection light and converting the projecting optical axis to a first or second optical axis. The photoelectric converting member is disposed on the second optical axis and prevents the projection light reflected by the photoelectric converting member from returning to the reflection control member.

According to the present invention, an unnecessary light which is not used for printing and exposing, or reading the image to be printed can be utilized effectively, so that power consumption can be reduced and it becomes possible to save the energy.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a schematic view of a print processor to which the present invention is applied;

FIG. 2 is a schematic view of a scanner in another embodiment of the present invention; and

FIG. 3 is a schematic view of a printer using a DMD in further embodiment of the present invention.

### DETAILED DESCRIPTION OF THE PREFERRED EMBODIMENTS

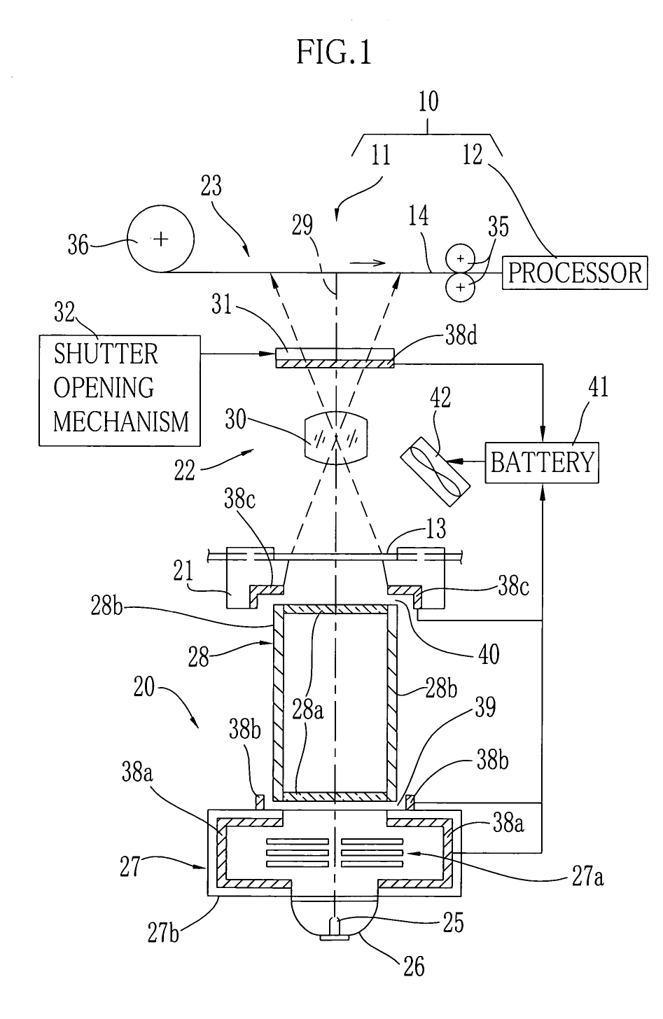

In FIG. 1, a print processor 10 is constituted of a printer 11 and a processor 12. The printer 11 is operated for exposing an image of a photographic film 13 in a printing paper 14. The processor 12 is used for developing the exposed printing paper 14 to make it a printed photograph (not shown).

A light source 20, a film carrier 21, an image forming optical unit 22 and a printing paper feeder 23 are disposed in the printer 11 one by one from the bottom of FIG. 1. The light source 20 is constituted of a halogen lamp 25, a reflector 26, a light-quality adjusting unit 27 and a diffusion box 28. When the halogen lamp 25 is lighted, the light from the halogen lamp 25 is emitted toward the light-quality adjusting unit 27. The light from the halogen lamp 25 is partially reflected by the reflector 26, and guided to the light-quality adjusting unit 27.

The light-quality adjusting unit 27 is provided with color filters 27a of cyan, magenta and yellow, filter sets (not shown) and a filter box 27b covering the color filters 27a. The filter sets inserts the color filters 27a into a printing optical axis 29, and adjusts the insertion amount of the color filters 27a in response to the image in the photographic film 13. The color balance of the light entered into the light-quality adjusting unit 27 is adjusted by the color filters 27a, and then transferred to the diffusion box 28.

The diffusion box 28 is constituted of a pair of light-diffusing plates 28a provided on the printing optical axis 29, and a reflecting plate 28b, which is provided so as to cover a gap generated between the light-diffusing plates 28a. The light entered into the diffusion box 28 is diffused to become an illumination light, and then transferred to the film carrier 21.

The photographic film 13 is held and fed by the film carrier 21 in the longitudinal direction to be set in the position where the image of the photographic film 13 to be printed is projected on the printing paper 14. The image set in the projecting position is illuminated by the illumination light from the diffusion box 28, and then exposed and printed in the printing paper 14 by the image forming optical unit 22.

The image forming optical unit 22 is constituted of a projection lens 30 and a black shutter 31. The black shutter 31 is open and closed by a shutter mechanism 32. The black shutter 31 is open when exposing and printing the image, while it is closed in order to block the light from the light source 20 in a standby state. Accordingly, the printing paper 14 is not exposed in the standby state.

The printing paper feeder 23 is provided with feeder roller pairs 35 for drawing and feeding the rolled printing paper 14. The printing paper 14 is wound into a roll shape and loaded into the printing paper feeder 23 as a printing paper roll 36. The printing paper 14 is intermittently fed by a length of one frame by the feeder roller pairs 35. The exposed printing paper 14 is fed to the processor 12 for development/fixing processes.

The light-quality adjusting unit 27, the diffusion box 28 and the film carrier 21 are constructed separately, so that a gap 39 is generated between the light-quality adjusting unit 27 and the diffusion box 28, and a gap 40 is also generated between the diffusion box 28 and the film carrier 21.

Solar battery panels 38a-38d generate the electricity after converting photoelectrically the unnecessary light, which is emitted from the halogen lamp 25 but does not reach the printing paper 14. The solar battery panel 38a is provided inside of the filter box 27b. The battery panels 38b and 38c are provided so as to cover the gaps 39, 40. The solar battery panel 38d is provided on the surface of the black shutter 31 to which the unnecessary light from the halogen lamp 25 is to be irradiated. The light deviated from the predetermined light path after reflected diffusely in the light-quality adjusting unit 27 is irradiated to the solar battery panel 38a. The light leaked from the gaps 39, 40 is irradiated to the solar battery panels 38b, 38c.

The solar battery panels 38a-38d are connected to a battery 41. The battery 41 charges the electricity generated by the solar battery panels 38a-38d. A cooling fan 42 is connected to the battery 41. The cooling fan 42 is driven by the electricity charged in the battery 41 and used to cool down the photographic film 13 set in the projecting position.

Next, the operation of the present embodiment is explained. The light emitted from the halogen lamp 25 in the standby state becomes the unnecessary light. The light from the halogen lamp 25 is transferred to the light-quality adjusting unit 27 and then the diffusion box 28 along the printing optical axis 29. In this time, part of the light entered to the light-quality adjusting unit 27 is reflected diffusely therein, and irradiated to the solar battery panel 38a. Additionally, part of the light traveling toward the diffusion box 28 is leaked from the gap 39, and then irradiated to the solar battery panel 38b.

The light diffused in the diffusion box 28 is irradiated to the film carrier 21 as the illumination light. At the same time, the light is partially irradiated to the solar battery panel 38c provided in the gap 40. The light emitted to the film carrier 21 is directly irradiated to the black shutter 31 through the projecting lens 30, and then blocked off by the black shutter 31. This illumination light is simultaneously irradiated to the solar battery panel 38d. Therefore, the unnecessary light emitted in the standby state can be converted into the electricity without a waste by the solar battery panels 38a-38d.

When printing is instructed, the image to be printed is set in the projecting position by the film carrier 21, while the unexposed part of the printing paper 14 is set in the predetermined position. Subsequently, the black shutter 31 is open by the shutter mechanism 32, and then the image illuminated by the illumination light is formed in the printing paper 14 by the projecting lens 30 to be exposed and printed. In printing the image as well as in the standby state, the unnecessary light is irradiated to the solar battery panels 38a-38c to be converted into the electricity.

When the printing has been completed, the black shutter 31 is closed, and the image to be printed is exposed in the printing paper 14 in sequence. The exposed printing paper 14 is fed to the processor 12 and then cut by a cutter (not shown) therein after developing and drying, and then ejected as the printed photograph.

The electricity generated by the solar battery panels 38a-38d is charged into the battery 41 and used as the energy for driving the cooling fan 42. In the print processor 10, the unnecessary light can be reused effectively not only in printing the image but in the standby state.

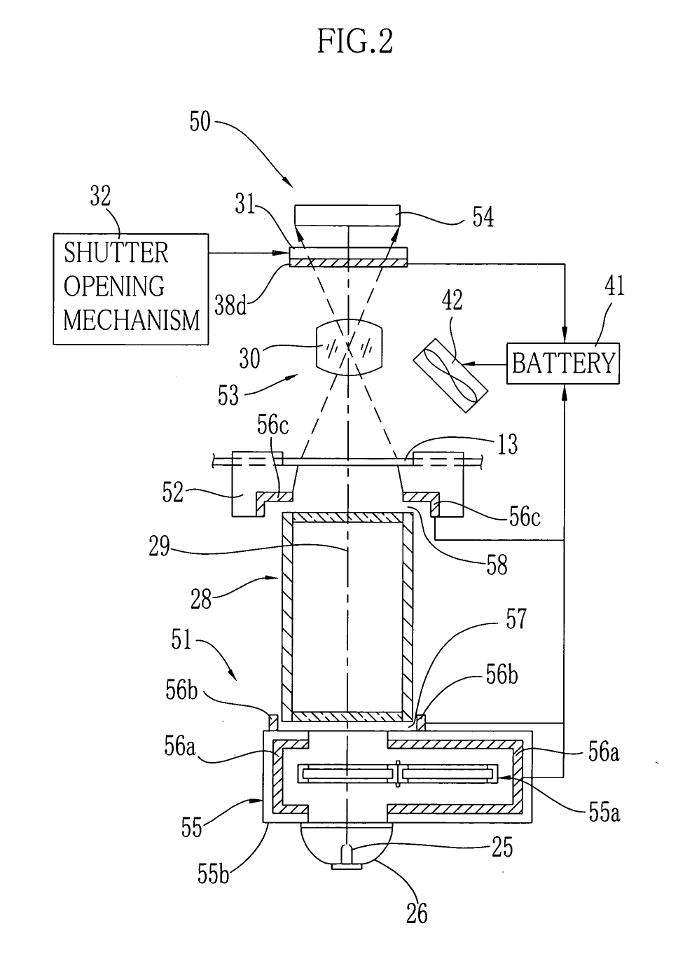

In the above embodiment, the analog print processor 10, in which the image of the photographic film 13 is printed in the printing paper 14 with the transmitted light, is explained. The present invention is also applied to a scanner to read the image on the photographic film. As shown in FIG.2, the scanner 50 has similar constitution to the printer 11 in the print processor 10: the scanner 50 is constituted of a light source 51, a film carrier 52, an image forming optical unit 53 and a CCD 54. However, the scanner 50 is, unlike the printer 11, provided with a balance filter unit 55 instead of the light-quality adjusting unit 27, and further provided with a CCD 54 as the imaging device instead of the printing paper feeder 23. Although the black shutter 31 is not necessarily provided in the scanner 50, the black shutter 31 for blocking the light emitted from the halogen lamp 25 in the standby state and the solar battery panel 38d are provided therein in order to utilize the unnecessary light effectively.

The balance filter unit 55 is constituted of a balance filter 55a and a filter case 55b, which covers the balance filter 55a. The balance filter 55a is used to correct the light irradiated to both the photographic film 13 and the CCD 54 according to the type of photographic film 13: a negative film or a positive film. A solar battery panel 56a is provided inside of the filter case 55b. As in the foregoing embodiment, solar battery panels 56b, 56c are provided so as to cover two gaps 57, 58: the gap 57 generated between the balance filter unit 55 and the diffusion box 28 and the gap 58 generated between the diffusion box 28 and the film carrier 52. The solar battery panels 56a-56c are connected to the battery 41 as well as the solar battery panel 38d according to the first embodiment. For example, the cooling fan 42 is driven by the electricity charged in the battery 41. Accordingly, in the scanner 50 as in the case of the printer 11, the unnecessary light can be reused effectively not only in reading the image but in the standby state.

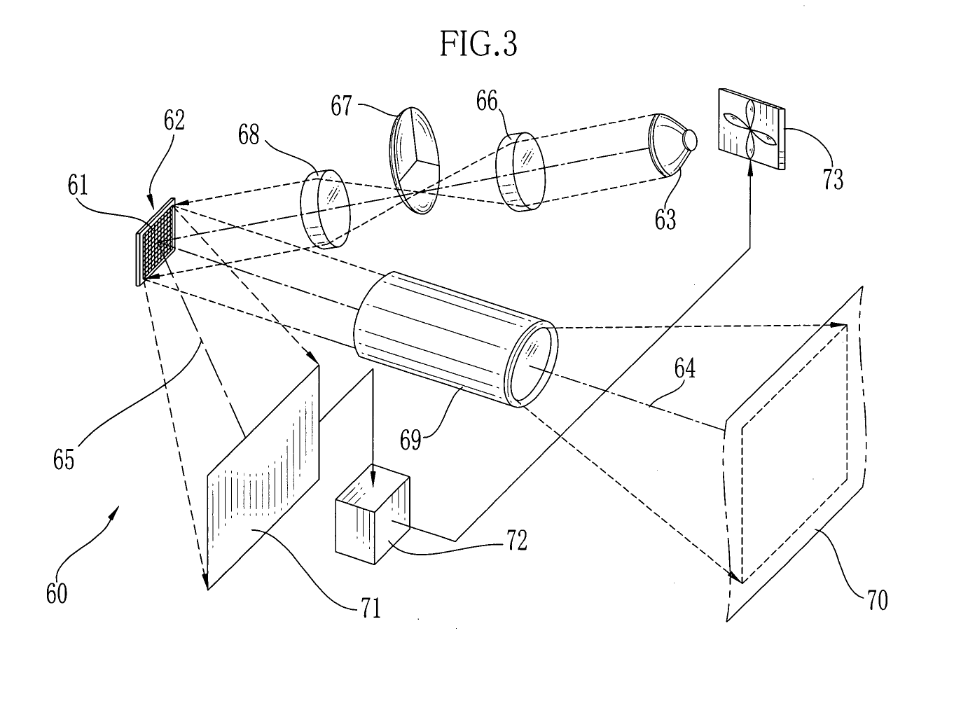

In the above embodiments, although the analog print processor 10 is explained, a digital print processor using a DMD may be applied to the present invention. As shown in FIG. 3, a printer unit 60 of the digital print processor is provided with a DMD 62 in which a large number of micromirrors 61 are arranged in a matrix.

The DMD 62 is capable of converting a reflection optical axis of the light emitted from a halogen lamp 63 to either a first optical axis 64 or a second optical axis 65 in accordance with image data. There are a condenser lens 66, a color filter wheel 67 and a relay condenser lens 68 in sequence between the halogen lamp 63 and the DMD 62. A projecting lens 69 and a printing paper 70, which is fed by a paper feeder (not shown), are disposed one by one in the first optical axis 64, which extends from the DMD 62. Meanwhile, a solar battery panel 71 is disposed in the second optical axis 65. Note that the solar battery panel 71 is slightly tilted with respect to the second optical axis 65 so as to prevent the light emitted from the solar battery panel 71 from being reflected by the DMD 62.

A battery 72 for charging the electricity generated by the solar battery panel 71 is connected thereto. A cooling fan 73 is connected to the battery 72, and located a position to cool down the halogen lamp 63. The cooling fan 73 is driven by the electricity charged in the battery 72.

The DMD 62 reflects unnecessary light, which is emitted from the halogen lamp 63 in the standby state, so that the light is converted to the second optical axis 65, and then the electricity is generated in the solar battery panel 71. At the time of printing, each micromirror 61 reflects the light from the halogen lamp 63 so that the light is converted to either the first optical axis 64 or the second optical axis 65 in accordance with pixel date, which constitutes the image data. Therefore, the unnecessary light can be utilized effectively both in the standby state and in printing the image.

In the present embodiments, although the photographic film is cooled down by the cooling fan, the halogen lamp may be cooled down thereby. In addition, the electricity charged in the battery may be used as the energy for driving a display panel, a built-in memory and so forth instead of the cooling fan.

Moreover, instead of the halogen lamp, another light source such as a light-emitting diode (LED) may be used as the light source in the present embodiment.

Furthermore, the present invention may be applied to a single printer or a printer for a large laboratory, other than the print processor for a mini-laboratory, the scanner and the digital print processor.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image forming apparatus to form an image in a photosensitive material by projecting an image recorded in an image carrying medium after irradiating projection light emitted from a light source to the image in said image carrying medium, said image forming apparatus comprising:
a photoelectric converting member for generating electricity by converting projection light which does not reach said photosensitive material.

2. An image forming apparatus as claimed in claim 1, further comprising:
a shutter member, arranged on a projecting optical axis that extends from said light source to said photosensitive material, for blocking said projection light traveling toward said photosensitive material; and
a shutter opening member for separating said shutter member from said projecting optical axis while said image is formed in said photosensitive material, said photoelectric converting member being attached on a surface of the light source side of said shutter member.

3. An image forming apparatus as claimed in claim 1, further comprising:
a light-quality adjusting section for adjusting a color balance of said projection light from said light source; and
a light diffusing section, arranged between said light-quality adjusting section and said image carrying medium, for diffusing said projection light, said photoelectric converting member being arranged in a position to cover a gap between said light-quality adjusting section and said light diffusing section.

4. An image forming apparatus as claimed in claim 1, further comprising:
a light diffusing section, arranged between said light source and said image carrying medium, for diffusing said projection light;
a feeding device for holding and feeding said image carrying medium, said photoelectric converting member being arranged in a position to cover a gap between said light diffusing section and said feeding device.

5. An image forming apparatus as claimed in claim 1, further comprising:
a light-quality adjusting section for adjusting said color balance of said projection light from said light source, wherein said light-quality adjusting section comprising:
plural color balance filters for changing intensity of component light of each color of said projection light; and
a housing for containing said plural color balance filters, said photoelectric converting member is attached on an inner surface of said housing.

6. An image forming apparatus as claimed in claim 1, said image carrying medium is a photographic film.

7. An image forming apparatus as claimed in claim 1, further comprising:
a charger connected to said photoelectric converting member for charging the electricity generated by said photoelectric converting member, the electricity in said charger being supplied to said image forming apparatus.

8. An image forming apparatus as claimed in claim 1, further comprising:
a reflection control member for reflecting said projection light and for converting an optical axis of said projection light to a first optical axis passing through said image carrying medium or a second optical axis which does not pass through said image carrying medium, said photoelectric converting member being disposed on said second optical axis.

9. An image forming apparatus as claimed in claim 8, wherein said reflection control member is a digital micro-mirror device in which plural micromirrors are arranged in a matrix.

10. An image forming apparatus as claimed in claim 8, wherein said photoelectric converting member is tilted with respect to said second optical axis, and prevents said projection light reflected by said photoelectric converting member from returning to said reflection control member.

11. An image scanning apparatus to generate image data corresponding to an image recorded in an image carrying medium by converting projection light photoelectrically in an image reading device after irradiating said projection light from a light source to said image in said image carrying medium and then projecting said image to said image reading device, said image scanning apparatus comprising:
a photoelectric converting member for generating electricity by converting photoelectrically projection light which does not reach said image reading device.

12. An image scanning apparatus as claimed in claim 11, further comprising:
a shutter member, arranged on a projecting optical axis that extends from said light source to said image reading device, for blocking said projection light traveling toward said image reading device; and
a shutter opening member separating said shutter member from said projecting optical axis while said projection light is irradiated to said image reading device, said photoelectric converting member being attached on a surface of the light source side of said shutter member.

13. An image scanning apparatus as claimed in claim 11, further comprising:
a light correcting section having plural balance filters to correct said projection light from said light source according to the type of said image carrying medium; and
a light diffusing section, arranged between said light correcting section and said image carrying medium, for diffusing said projection light, said photoelectric converting member being arranged in a position to cover a gap generated between said light correcting section and said light diffusing section.

14. An image scanning apparatus as claimed in claim 11, further comprising:
a light diffusing section, arranged between said light source and said image carrying medium, for diffusing said projection light; and
a feeding device for holding and feeding said image carrying medium, said photoelectric converting member being arranged in a position to cover a gap between said light diffusing section and said feeding device.

15. An image scanning apparatus as claimed in claim 11, further comprising:
a light correcting section for correcting said projection light from said light source according to the type of said image carrying medium, wherein said light correcting section comprising:
plural balance filters provided for each of said image carrying medium; and
a housing for containing said plural balance filters, said photoelectric converting member is attached on an inner surface of said housing.

16. An image scanning apparatus as claimed in claim 11, said image carrying medium is a photographic film.

17. An image scanning apparatus as claimed in claim 11, further comprising:
a charger, connected to said photoelectric converting member, for charging the electricity generated by said photoelectric converting member, the electricity in said charger being supplied to said image scanning apparatus.

18. An image forming apparatus forming an image in a photosensitive material by projecting an image recorded in a photographic film to said photosensitive material after irradiating projection light from a light source to said image in said photographic film, said image forming apparatus comprising:
a light-quality adjusting section for adjusting a color balance of said projection light from said light source;
a light diffusing section, arranged between said light-quality adjusting section and said photographic film, for diffusing said projection light;
a feeding device for holding and carrying said photographic film;
a shutter member, arranged on a projecting optical axis that extends from said light source to said photosensitive material, for blocking said projection light traveling toward said photosensitive material; and
a photoelectric converting member being provided in at least one of a surface of the light source side of said shutter member, a position to cover a gap between said light-quality adjusting section and said light diffusing section, a position to cover a gap between said light diffusing section and said feeding device and an inside of said light-quality adjusting section, said photoelectric converting member generating electricity by converting photoelectrically projection light which does not reach said photosensitive material.

19. An image scanning apparatus generating image data of an image recorded in a photographic film by projecting said image in said photographic film to an imaging device after irradiating projection light from a light source to said image, said image scanning apparatus comprising:
a light correcting section having plural balance filters to correct said projection light from said light source according to the type of said photographic film;
a light diffusing section, arranged between said light correcting section and said photographic film, for diffusing said projection light;
a feeding device for holding and feeding said photographic film;
a shutter member, arranged on a projecting optical axis that extends from said light source to said imaging device, for blocking said projection light traveling toward said imaging device; and
a photoelectric converting member being provided in at least one of a surface of the light source side of said shutter member, a position to cover a gap between said light correcting section and said light diffusing section, a position to cover a gap between said light diffusing section and said feeding device and an inside of said light correcting section, and said photoelectric converting member generating electricity by converting photoelectrically projection light which does not reach said imaging device.

20. An image forming apparatus forming an image in a photosensitive material by projecting an image recorded in a photographic film to said photosensitive material after irradiating projection light from a light source to said image in said photographic film, said image forming apparatus comprising:
a digital micro-mirror device in which plural micromirrors are arranged in a matrix for converting an optical axis of said projection light to either a first optical axis passing through said photographic film or a second optical axis which does not pass through said photographic film; and
a photoelectric converting member, arranged on said second optical axis, for generating electricity by converting photoelectrically said projection light which does not pass through said photographic film.
